(19) United States
(12) Patent Application Publication
(10) Pub. No.: US 2025/0262847 A1
(43) Pub. Date: Aug. 21, 2025

(54) STRUCTURE AND METHOD FOR ENVIRONMENTALLY FRIENDLY BLISTER PACKAGING

(71) Applicant: Multisorb Technologies, Inc., Buffalo, NY (US)

(72) Inventor: Narasimharao Dontula, Henrietta, NY (US)

(21) Appl. No.: 19/052,835

(22) Filed: Feb. 13, 2025

Related U.S. Application Data
(60) Provisional application No. 63/634,192, filed on Apr. 15, 2024.
(60) Provisional application No. 63/554,653, filed on Feb. 16, 2024.

(51) Int. Cl. B32B 27/08; B32B 7/02; B32B 27/18; B32B 27/30; B32B 27/32; B65D 75/36; B65D 81/26

(52) U.S. Cl. CPC B32B 27/08; B32B 7/02; B32B 27/18; B32B 27/304; B32B 27/306; B32B 27/325; B65D 75/367; B65D 81/266; B32B 2255/10; B32B 2255/26; B32B 2264/102; B32B 2270/00; B32B 2307/72; B32B 2307/7246; B32B 2307/7376; B32B 2307/738; B32B 2439/80

(57) ABSTRACT

A sustainable, environmentally-friendly structure and method for blister packaging comprising, in certain aspects, one or more active moisture barrier layer including a first moisture absorbing composition and a COC, and one or more passive moisture barrier layers. The multilayer structure may be asymmetric, with active layers in a coextruded structure of different thicknesses, for example. A method of forming a sustainable moisture absorbing multilayer structure includes formation of a base structure including one or more first passive moisture barrier layers, and one or more active moisture barrier layers. In certain aspects, the composite density of the multilayer structure is lower than commercially available structures. In other aspects, non-halogenated, environmentally-friendly materials are utilized in various or all layers.

### CROSS-REFERENCE TO RELATED APPLICATIONS

This application claims the benefit under 35 U.S.C. § 119(e) of U.S. Provisional Patent Application No. 63/554,653, filed on Feb. 16, 2024, and of U.S. Provisional Patent Application No. 63/634,192, filed on Apr. 15, 2024, which applications are incorporated by reference herein in their entireties.

### TECHNICAL FIELD

The present invention relates to non-halogenated polymeric moisture barriers and, more specifically, to improved multilayer moisture barriers including both passive and active moisture barrier layers created using non-halogenated polymers. In certain aspects, the present invention comprises thermoformable multilayer moisture barrier structures having both passive and active moisture barrier layers. In other aspects, non-halogenated polymeric moisture barriers are used in combination with lesser amounts of halogenated passive barriers.

### BACKGROUND

Many applications require a moisture barrier and/or absorber. For example, some pharmaceutical and nutraceutical products (e.g. tablets, capsules or lozenges) and food products degrade upon exposure to oxygen and/or moisture. Product degradation may to occur due to either oxidation, or hydrolysis or both, for example. Preventing or reducing exposure to moisture can prolong the useful life of such items. Hence, packaging materials and separate inserts to packaging may be provided with moisture absorbing and/or oxygen absorbers. One approach to protect the pharmaceutical and nutraceutical tablets, capsules or lozenges and food products is blister packaging. Blister packs in the prior art might be characterized by a base film structure containing several cavities made by a shaping process step known as thermoforming process. Cavities are typically separated from each other, with each cavity able to be filled by a single pharmaceutical or unit dose. A backing film or lidding film may be applied to the base film structure that has been shaped to form a blister and filled with doses. In certain aspects, the backing or lidding film encloses and protects the product due to its barrier characteristics.

Blister packaging, and the like, provide benefits over other pharmaceutical packaging like pill bottles. For example, it is apparent if a person has taken a particular medication, thereby providing a simple compliance verification mechanism. Moreover, separately packaged medicaments facilitate minimizing exposure to oxygen and moisture as each separate dose may be used without environmental exposure of other doses.

### BRIEF SUMMARY OF THE INVENTION

With reference to corresponding parts, portions or surfaces of the disclosed embodiment, merely for the purposes of illustration and not by way of limitation, the present disclosure provides an improved, environmentally friendly structure and method for blister packaging.

The ingress of moisture or oxygen through product packaging may be controlled by passive barrier characteristics of the polymers used for the packaging. Passive barrier characteristics are determined by inherent properties of the polymer like permeability which is a function of diffusivity and solubility of the solute (like moisture or oxygen) that ingresses through the packaging. A further packaging design characteristic or variable is the thickness of the polymer layer or layers used to get the required water vapor or gas transmission rates in order to get desired shelf life for the product being protected. In some aspects, the novel structure and method disclosed herein uses moisture absorbers or adsorbers or desiccants in a multilayer polymer system to reduce the ingress of moisture over the desired product shelf life.

One benefit of the present invention is the reduction of the amount of halogen containing polymers (such as polychlorotrifluoroethylene (PCTFE), polyvinyl chloride (PVC) and polyvinylidene chloride (PVDC)) in packaging applications due to environmental concerns throughout lifecycle of use as well difficulties in recycling. Similarly, the use of aluminum foil in blister packaging may present difficulties with recycling.

The present invention relates broadly to moisture absorbing and/or barrier systems and film structures in packaging that use less or no halide-containing polymers (e.g. PVC, PCTFE, PVDC), and reduces or minimizes environmental issues during the lifecycle and recycling. In addition, certain aspects of the disclosed embodiments relate to moisture absorbing film structures that can be formed without degrading their suitability for subsequent thermoforming operations (e.g., forming into packaging such as blisters). These and other objects and advantages of the present invention will be readily appreciated from the following description of various embodiments and from the accompanying drawings and the appended claims.

Hereinafter, moisture absorber and moisture adsorber are used interchangeably with reference to additives that react or hold or capture moisture. Also as used hereinafter, the polymer layer, the moisture absorber or adsorber or desiccant incorporated in a polymer or resin will be specified as an active layer since this layer has an active additive that captures moisture. In a preferred embodiment, active ingredient(s) are incorporated in a non-halogenated polymer resin, preferably cyclic olefin copolymer (COC) and its blends and polyolefins; that is then formed into an active moisture barrier layer and forms part of a multilayer polymer structure. The improved structures and methods described herein result in an unexpected finding that certain non-halogenated multilayer polymer structures have a lower composite density than commercial halogenated polymer structures (containing PVC, PCTFE).

For cases of equivalent moisture ingress over the product shelf life, the present invention highlights in some aspects that a roll of non-halogenated polymer multilayer structure will weigh less than a roll made using halogenated polymers. Hence, the final user (pharmaceutical or nutraceutical or food company, or their contract manufacturers, for example) will pay less in transportation costs if one of the preferred embodiments is used. Also, being lower in weight means less polymer being used resulting in lower cost. The environmentally friendly solutions described herein are also beneficial because COCs and also polyolefins are currently recycled commercially by mechanical recycling techniques, and may also be chemically recycled. This leads to the recycled olefins which may be re-purposed or reused. In contrast, for halogenated polymer structures, there are significant challenges to recycling PVC and hence it is typically landfilled or incinerated, and no commercial process yet exists to recycle PCTFE. This results in PCTFE being incinerated or landfilled. Hence overall, one or more of the preferred embodiments of the current invention incorporates an active moisture absorbing ingredient in a layer of cyclic olefin or its blends. In one aspect, this layer forms a part of the multilayer non-halogenated polymer structure and is an environmentally-friendly solution.

One embodiment of the improved structure and method broadly comprises a multilayer structure including, in order, a first passive moisture barrier layer, a first active moisture barrier layer including a moisture absorbing composition and a COC, and a second passive moisture barrier layer. In this embodiment, the first and second passive moisture barrier layers and the first active moisture barrier layer may be contiguous, non-contiguous or combinations thereof. One of the preferred methods of manufacturing the multilayer laminate structure is by a one step process like co-extrusion where all the layers of the laminate are combined in a feedblock or multi-manifold die and cast on cooling roll or roll stack to form a film or sheet. As used herein, “film” is anything less than or equal to 10 mil (or 0.0254 cm or 254 microns) in thickness, and a “sheet” is a material that is greater than 10 mil (254 microns) in thickness. In one embodiment of the invention, all the layers of the novel multilayer structure may be made from non-halogenated polymers.

Another embodiment of the improved structure and method broadly comprises a multilayer structure including, in order, a first passive moisture barrier layer, a first active moisture barrier layer including a moisture absorbing composition and a COC, and a second and third passive moisture barrier layer, where the third passive moisture barrier layer is also a sealant layer. The first, second and third passive moisture barrier layers and the first active moisture barrier layer may be contiguous, non-contiguous or combinations thereof. In one embodiment, all the layers of the multilayer structure are made from non-halogenated polymers.

Yet another embodiment of the improved structure and method for sustainable blister packaging broadly comprises a multilayer structure including, in order, a first passive moisture barrier layer, a second passive moisture barrier layer, a first active moisture barrier layer including a moisture absorbing composition and a COC, and a third passive moisture barrier layer. The first, second and third passive moisture barrier layers and the first active moisture barrier layer may be contiguous, non-contiguous or combinations thereof.

Another embodiment of the improved structure and method broadly comprises a thermoformed article formed from a multilayer structure including, in order, a first passive moisture barrier layer, a second passive moisture barrier layer, a first active moisture barrier layer including a moisture absorbing composition and a COC and its blends, and a third passive moisture barrier layer. The first, second and third passive moisture barrier layers and the first active moisture barrier layer may be contiguous, non-contiguous or combinations thereof. In one embodiment, the first, second and third passive moisture barrier layers each include a modulus of elasticity less than or equal to a modulus of elasticity of the first active moisture barrier layer.

In a further embodiment, the improved structure and method broadly comprises a container for extending the shelf life of moisture degradable pharmaceutical products including a thermoformed article formed from a multilayer structure including, in order, a first passive moisture barrier layer, a second passive moisture barrier layer, a first active moisture barrier layer including a moisture absorbing composition and a COC and its blends, and a third passive moisture barrier layer. The first, second and third passive moisture barrier layers and the first active moisture barrier layer may be contiguous, non-contiguous or combinations thereof. The first, second and third passive moisture barrier layers each include a modulus of elasticity less than or equal to a modulus of elasticity of the first active moisture barrier layer. In one aspect of this embodiment, the thermoformed article forms a plurality of pill receiving chambers.

In yet another embodiment of the invention, the present invention broadly comprises a method of forming a moisture absorbing multilayer structure including: a) forming a multilayer laminate structure including, in order, a first passive moisture barrier layer, a first active moisture barrier layer and a second passive moisture barrier layer, the first active moisture barrier layer having a first side and a second side opposite the first side and including a moisture absorbing composition and a COC and its blends, the first passive moisture barrier layer disposed on the first side, and the second passive moisture barrier layer disposed on the second side; and, b) coating a third passive moisture barrier layer on the multilayer laminate structure. In some embodiments, the structure is a thermoformable passive and active moisture barrier and/or absorber.

In one embodiment, the present invention provides a multilayer, asymmetric sustainable moisture barrier for a blister pack, comprising a first passive layer comprising a non-halogenated polymer; a first active layer comprising COC and a moisture absorbing composition; and a second passive layer comprising a non-halogenated polymer; wherein the passive layers are not equal in thickness; the first passive layer and the first active layer are not equal in thickness; and the modulus of elasticity of the passive layers is lower than the modulus of elasticity of the first active layer. In one aspect, the first passive layer, second passive layer and first active layer are co-extruded. In another aspect, the passive layers and first active layer comprise polyolefins or copolymers of polyolefins. Another embodiment includes a second active layer comprising COC and a moisture absorbing composition wherein the first active layer and second active layer are not equal in thickness. In certain aspects, the ratio between the combined thickness of the active layers and the thickness of the entire multilayer structure is between 0.41:1 and 0.82:1. At least one of the active layers may be selected from the group of: polypropylene (PP), amorphous polyester (APET), and ethylene vinyl acetate (EVA), and the moisture absorbing composition in the active layers may be selected from the group consisting of calcium oxide, silica gel and molecular sieve. In one embodiment, the moisture absorbing composition in the active layers are different. In another aspect, the first passive layer and second passive layer are contiguous with the first active layer, and the ratio between the combined thickness of the passive layers and the thickness of the first active layer is between 0.18:1 and 0.61:1.

In one embodiment, the multilayer, sustainable moisture barrier structure may include a first primer layer disposed between the first passive layer and second passive layer, with the first primer layer configured to enhance adhesion between adjacent layers. In one aspect, the first passive layer is an aqueous solution deposited on said first primer layer and, in another, the first passive layer is the outermost layer. The present invention may also include a third passive layer comprising a non-halogenated polymer; a fourth passive layer comprising a non-halogenated polymer; and a second primer layer disposed between the third and fourth passive layers. The first primer layer may be an EVA copolymer, a maleic anhydride modified polyolefin, ethylene methyl acrylate (EMA), ethylene butyl acrylate (EBA), ethylene ethyl acrylate (EEA), copolymer of ethylene and glycidyl methacrylate, terpolymers of ethylene, methyl acrylate and glycidyl methacrylate, terpolymer of ethylene, or butyl acrylate and glycidyl methacrylate; and the first primer layer serves as a sealant layer. In certain aspects, the moisture absorbing compositions are selected from the group consisting of calcium oxide, silica gel, activated alumina and molecular sieve, and in other aspects, the first passive layer comprises ethylene vinyl alcohol (EVOH) for providing an oxygen barrier, wherein the first passive layer is coextruded with said first active layer. In one embodiment, the total thickness of the multilayer structure is less than 508 microns, and its composite density is less than 1.25 g/cc. The present invention also includes a thermoformed container comprising the sustainable moisture barrier structures described above.

One embodiment of the present invention provides an asymmetric, multilayer sustainable moisture barrier, comprising: a first non-halogenated passive moisture barrier layer; a first active moisture absorbing layer contiguous with said first passive moisture barrier layer, comprising COC and a moisture absorbing composition; a second non-halogenated passive moisture barrier layer; a second active moisture absorbing layer contiguous with said second passive moisture barrier layer, comprising COC and a moisture absorbing composition; and a third non-halogenated passive moisture barrier layer; wherein the active moisture absorbing layers are not equal in thickness, and the non-halogenated passive moisture barrier layers are also not equal in thickness. In one aspect of a preferred embodiment, both of the second and third passive moisture barrier layers have a modulus of elasticity less than or equal to the modulus of the active moisture absorbing layers. In another aspect, the first passive moisture barrier layer, second passive moisture barrier layer and first active moisture absorbing layer are co-extruded.

In one aspect of the invention, a multilayer, sustainable moisture barrier for a blister pack, comprises (a) a first passive layer comprising a non-halogenated polymer; (b) a first active layer comprising COC or COC blends and a moisture absorbing composition; and (c) a second passive layer comprising a non-halogenated polymer; and the modulus of elasticity of the first and second passive layers is lower than the modulus of elasticity of said first active layer. In another aspect, the first passive layer, second passive layer and first active layer are co-extruded. In yet another aspect, the first passive layer, second passive layer and first active layer comprise polyolefins or copolymers of polyolefins. Some embodiments include a second active layer comprising COC or COC blends and a moisture absorbing composition. In others, the first active layer and said second active layer are not equal in thickness. In one aspect, the ratio between the combined thickness of the first active layer and second active layer, and the thickness of the entire multilayer moisture barrier, is between 0.41:1 and 0.82:1. At least one of the first active layer and second active layer may be selected from the group of: polypropylene (PP), amorphous polyester (APET), and ethylene vinyl acetate (EVA); and the moisture absorbing composition in the first active layer may be selected from the group consisting of calcium oxide, silica gel, activated alumina and molecular sieve; and the moisture absorbing composition in the second active layer is a different moisture absorbing composition. The multiplayer structure may be asymmetric, with the first and second passive layers, for example, are not equal in thickness.

In one aspect of the invention, the first passive layer and second passive layer are contiguous with the first active layer, and the ratio between the combined thickness of the first passive layer and second passive layer, and the thickness of the first active layer, is between 0.18:1 and 0.61:1. In yet another aspect, a sustainable moisture barrier further comprises a first primer layer disposed between the first passive layer and second passive layer, where the first primer layer is configured to enhance adhesion between adjacent layers. In some embodiments, the first passive layer is an aqueous solution deposited on the first primer layer, and in others the first passive layer is the outermost layer.

Other embodiments of the invention include: a third passive layer comprising a non-halogenated polymer; a fourth passive layer comprising a non-halogenated polymer; and a second primer layer disposed between the third passive layer and fourth passive layer. The first primer layer may include an EVA copolymer, a maleic anhydride modified polyolefin, ethylene methyl acrylate (EMA), ethylene butyl acrylate (EBA), ethylene ethyl acrylate (EEA), copolymer of ethylene and glycidyl methacrylate, terpolymers of ethylene, methyl acrylate and glycidyl methacrylate, terpolymer of ethylene, or butyl acrylate and glycidyl methacrylate. The moisture absorbing composition may be selected from the group consisting of calcium oxide, silica gel and molecular sieve; and the first passive layer may include comprise ethylene vinyl alcohol (EVOH) for providing an oxygen barrier; and wherein the first passive layer is coextruded with said first active layer.

In some aspects, the first primer layer serves as a sealant layer. One embodiment of the invention is a thermoformed container comprising the sustainable moisture barrier described above. In some embodiments, the total thickness of the multilayer structure is less than 508 microns, and its composite density is less than 1.25 g/cc.

Another embodiment of the invention provides a multilayer sustainable moisture barrier, comprising: (a) a first non-halogenated passive moisture barrier layer; (b) a first active moisture absorbing layer contiguous with the first passive moisture barrier layer, comprising cyclic olefin copolymer (COC) or COC blends and a moisture absorbing composition; (c) a second non-halogenated passive moisture barrier layer; (d) a second active moisture absorbing layer contiguous with the second passive moisture barrier layer, comprising cyclic olefin copolymer (COC) or COC blends and a moisture absorbing composition; and (e) a third non-halogenated passive moisture barrier layer. The multilayer structure may be asymmetric and may include first and second active moisture absorbing layers which are not equal in thickness and/or first, second and third non-halogenated passive moisture barrier layers are also not equal in thickness.

The novel moisture barrier may comprise second and third passive moisture barrier layers having a modulus of elasticity less than or equal to the modulus of the first and second active moisture absorbing layers. In another aspect, the first passive moisture barrier layer, second passive moisture barrier layer and first active moisture absorbing layer are co-extruded. Another embodiment of the invention is a thermoformed container comprising the multilayer structures described above.

“Sustainable” or “sustainability” is broadly used herein. Sustainable solutions are environmentally friendly solutions. This encompasses areas where this disclosure highlights the use of non-halogenated polymers to create a structure that is amenable to recycling; use of less halogenated polymers; use of less amount of polymer which leads to a lower carbon footprint either to produce it, or to transport rolls of the multilayer structures, and other areas known to those skilled in the art.

### BRIEF DESCRIPTION OF THE DRAWINGS

FIG. 1 is a top perspective view of an article formed from a thermoformable multilayer moisture barrier structure, i.e., a blister pack.

FIG. 2 is a bottom perspective view of the article of FIG. 1.

FIG. 3 is a chart illustrating typical water vapor transmission rate (WVTR) curves for passive polymeric layer and active layer as a function of time.

FIG. 4 is a schematic of ingress through a passive polymeric layer and an active polymeric layer as function of time.

FIG. 5 is a cross-sectional view of an embodiment of a thermoformable multilayer moisture barrier structure.

FIG. 6 is a cross-sectional view of an embodiment of a thermoformable multilayer moisture barrier structure.

FIG. 7 is a cross-sectional view of an asymmetric multilayer moisture barrier structure.

### DETAILED DESCRIPTION OF THE EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read together with the specification, and are to be considered a portion of the entire written description of this invention.

As used herein, “blister”, “blister pack” and “single dose unit” may be used interchangeably and refer to structures used to contain single doses of pharmaceutical materials, and all structures similar thereto. “Moisture barrier”, as used herein, refers to a material which impedes the transmission of moisture. Such materials have water vapor transmission rates (WVTR's) as dictated by the needs of the overall multilayer structure. For example, some applications may require a WVTR of

$$0.07 \frac{g}{100 {in}^{2} \cdot 24 hrs} ,$$

while other applications may require a lower WVTR such as

$$0.02 \frac{g}{100 {in}^{2} \cdot 24 hrs} .$$

Moisture barrier characteristics may be altered by a variety of means, e.g., applying more layers of moisture barrier materials, applying thicker layers of moisture barrier materials, applying different moisture barrier materials that have different permeabilities or WVTR's, or incorporating different moisture absorbing compositions within a polymer layer, etc. It should be appreciated that the foregoing WVTRs are not intended to be limiting, and the WVTR for each particular embodiment is dictated by the needs of the overall multilayer structure. It should be appreciated that WVTR is the steady state moisture transmission time through a packaging system, under specific conditions of temperature and humidity. Test methods may include, but are limited to, gravimetric measurement to determine the rate of weight gain as a result of water vapor transmission into the packaging system and subsequent uptake by a desiccant enclosed within the packaging system. Some instruments offered by Mocon and Systech Illinois measure WVTR by challenging one side of a sample with a permeant or test gas, e.g., water vapor, while the opposite side of the sample is swept with a carrier gas. Molecules of permeant diffuse through the sample film and are carried to a sensor by the carrier gas. A computer or processor monitors the increase in water vapor in the carrier gas, and reports values of transmission rate. Typical sensors used to measure water vapor concentration are infrared (IR) and phosphorous pentoxide.

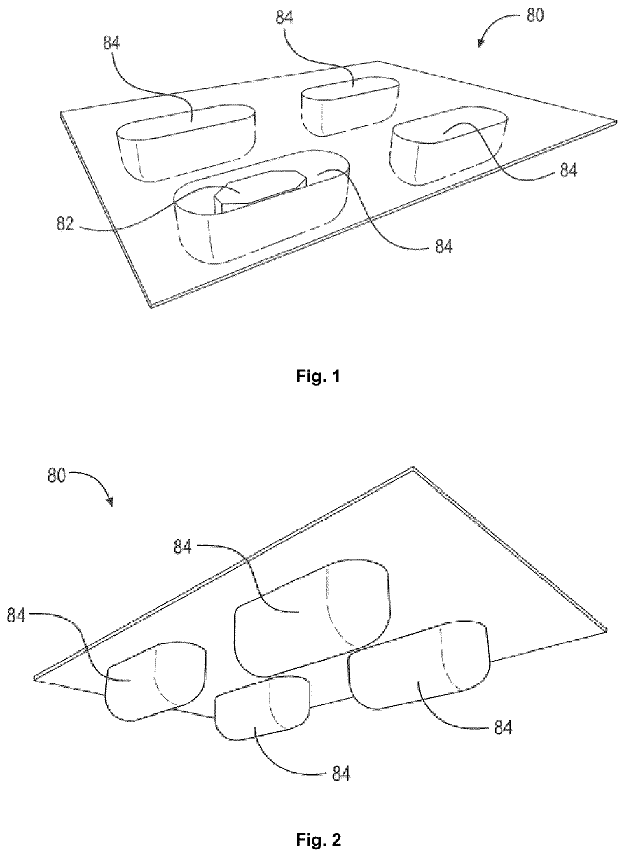

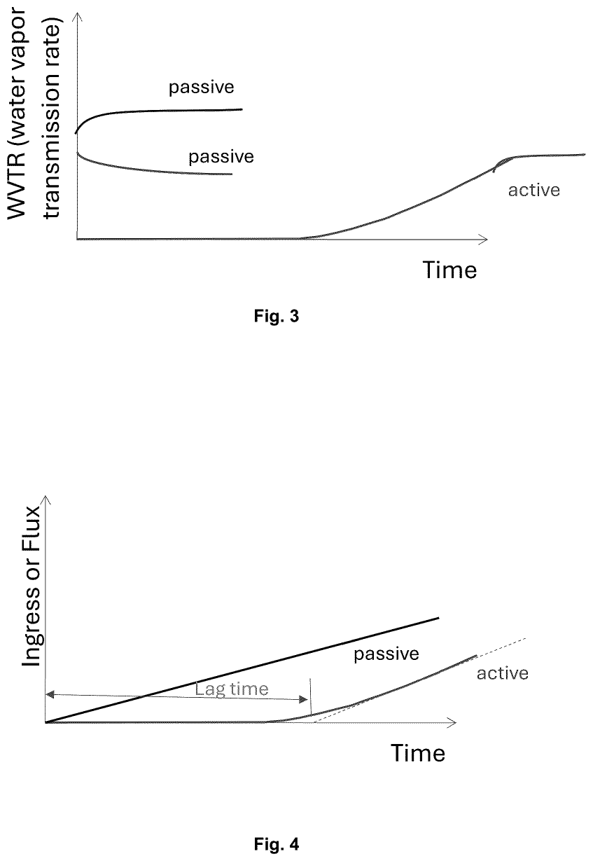

Referring now to the drawings, FIGS. 1 and 2 illustrate a blister pack 80 with a plurality of cavities 84 containing one or more products such as a pharmaceutical or unit dose 82, which blister pack comprises a thermoformable multilayer moisture barrier structure. FIG. 3 is a graph showing typical WVTR curves obtained for a passive polymer structure and a packaging structure containing the active layer. As it is observed, the passive structure stabilizes to a steady state value rapidly. In contrast, the shape of the curve for the active layer structure shows no moisture being sensed by the WVTR sensor initially and then after some time non-zero values for WVTR are attained as the active additive is consumed. Once it is fully expended, the WVTR reaches a steady state corresponding to the passive polymer properties.

FIG. 4 is a schematic representation of moisture ingress or flux through a passive packaging polymer structure and a packaging polymer structure containing an active layer. The curves in FIG. 4 are obtained from the integration of area under the curves of FIG. 3. It is observed that the curves are different. As noted earlier, the packaging polymer structure containing the active layer initially has no ingress or flux through it, since the moisture is being consumed by the active ingredient or moisture absorber or adsorber. Once this moisture absorber is consumed there is ingress through the polymer structure and the rate (represented by the slope of the line) will be equivalent to the composite permeability of polymers used to create the polymer structure. In certain aspects of present invention, non-halogenated polymer active layers are assembled with non-halogenated passive layers to form a multilayer structure, and lag times are tailored such that the total moisture ingress over the shelf life (typically two years at 25 C/60% RH for pharmaceutical single unit oral doses) is the same or similar to structures using halogenated polymers. In other aspects of the invention, active layers of non-halogenated polymers are combined with lesser amounts of halogenated polymers.

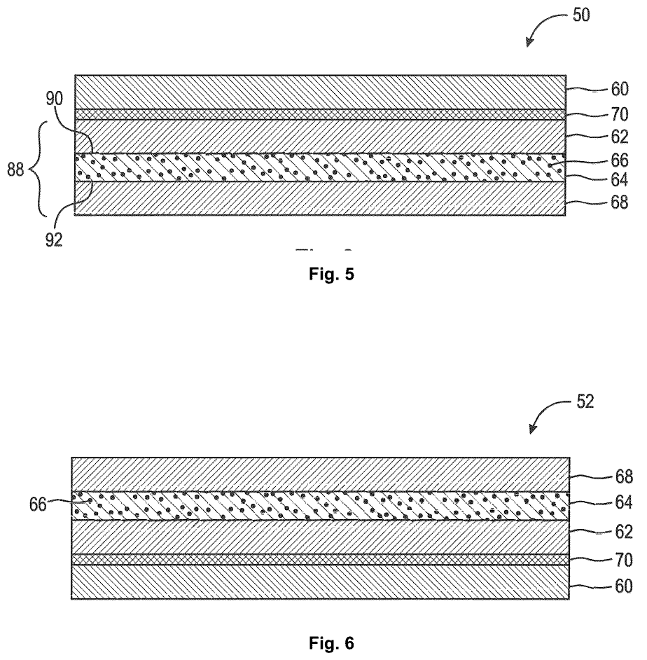

Some non-limiting examples of a present multilayer structure are depicted in FIGS. 5 and 6 as multilayer structures 50, 52. In one embodiment, the multilayer structure, an active and passive moisture barrier, comprises, in order, first passive moisture barrier layer 60, second passive moisture barrier layer 62, first active moisture barrier layer 64, and third passive moisture barrier layer 68. In this embodiment, the first active moisture barrier layer 64 comprises moisture absorbing composition 66 and a COC. The first, second and third passive moisture barrier layers and the first active moisture barrier layer may be contiguous, non-contiguous or combinations thereof.

In some embodiments, the first, second and third passive moisture barrier layers and the first active moisture barrier layer collectively comprise a thickness of less than or equal to about 508 microns. In some embodiments, the present multilayer structure has a ratio of the sum of the thicknesses of the second and third passive moisture barrier layers, i.e., the passive moisture barrier layers immediately adjacent the active moisture barrier layer, to the thickness of the first active moisture barrier layer ranging from 0.18:1 to 0.61:1. In some embodiments, the ratio of the sum of the thicknesses of the active layers to the overall final structure thickness ranges from 0.41:1 to 0.84:1.

It should be appreciated that the present multilayer structure in certain embodiments of the invention is thermoformable such that a variety of molded articles may be manufactured using the novel multilayer structure described herein. An advantage of some embodiments of the present multilayer structure is that they have formulations that in addition to be melt extrudable, are also melt processable via techniques such as extrusion or injection molding into moisture absorbing films, sheets or containers. An example of such a formulation includes a case where all the layers made of polyolefins or copolymers of polyolefins, and their blends.

In certain embodiments of the invention, the active moisture barrier layer and closest passive moisture barrier layers to the active moisture barrier layer are co-extruded. For example, passive moisture barrier layers 62 and 68 may be coextruded simultaneously with active moisture barrier layer 64. Moreover, in some embodiments the entire structure containing passive moisture barrier layers 60, 62, 68 are coextruded simultaneously with active moisture barrier layer 64. In some embodiments, some or all of the layers in the multilayer structure are separately extruded and then laminated to each other in a subsequent forming operation, e.g., using adhesive, sonic welding, heat, etc.

Various embodiments of the present invention may also include additional layers within the overall structure. In some embodiments, the multilayer structure further comprises first primer layer 70 disposed between first passive moisture barrier layer 60 and second passive moisture barrier layer 62. First primer layer 70, first active moisture barrier layer 64 and second and third passive moisture barrier layers 62 and 68, respectively, are co-extruded. In some embodiments, first passive moisture barrier layer 60 is an aqueous solution prior to deposit on first primer layer 70, and in some of those embodiments, first passive moisture barrier layer 60 comprises PVDC and its copolymers. In some embodiments, first passive moisture barrier layer 60 comprises PVC and/or amorphous polyethylene terepthalate (APET). In some embodiments including first primer layer 70, the present multilayer structure collectively comprises a thickness of less than or equal to about 508 microns. In some embodiments, first passive moisture barrier layer 60 and first primer layer 70 are co-extruded onto an intermediate multilayer structure comprising, in order, second passive moisture barrier layer 62, first active moisture barrier layer 64 and third passive moisture barrier layer 68.

Variations of the disclosed multilayer structures can be designed based on application requirements or need to increase manufacturing process window or possibly overcome equipment limitations to deliver a certain layer thickness. Some of these structure variations in certain embodiments of the invention include a five-layer structure where a first passive/first active/second passive/second active/third passive structure is created for a given overall thickness of less than or equal to about 508 microns. Also, the ratio of a sum of the thicknesses of the first, second and third passive moisture barrier layers to a sum of the thicknesses of the first and second active moisture barrier layers ranging from 0.18:1 to 0.61:1. Moreover, it has a ratio of the sum of the thicknesses of the active moisture barrier layers to the total thickness of the structure ranging from 0.41:1 to 0.84:1.

Another embodiment comprises a first passive/primer/second passive/first active/third passive/second active/fourth passive layer structure. The overall thickness of the structure is less than or equal to about 508 microns where the ratio of a sum of the thicknesses of the second, third and fourth passive moisture barrier layers to a sum of the thicknesses of the first and second active moisture barrier layers ranging from 0.18:1 to 0.61:1. Moreover, it has a ratio of the sum of the thicknesses of the active moisture barrier layers to the total thickness of the structure ranging from 0.41:1 to 0.84:1.

In some embodiments, the present multilayer structure further comprises, after fourth passive moisture barrier layer, fifth passive moisture barrier layer. The first, second, third, fourth and fifth passive moisture barrier layers and the first and second active moisture barrier layers may be contiguous, non-contiguous or combinations thereof. In some embodiments, the present multilayer structure further comprises first primer layer disposed between first passive moisture barrier layer and second passive moisture barrier layer, and/or second primer layer disposed between fourth passive moisture barrier layer and fifth passive moisture barrier layer. In some embodiments, the first and second active moisture barrier layers and the second, third and fourth passive moisture barrier layers are co-extruded, and the first, second, third, fourth and fifth passive moisture barrier layers and the first and second active moisture barrier layers are contiguous, non-contiguous or combinations thereof.

In some embodiments, at least one of the first and fifth passive moisture barrier layers is an aqueous solution prior to deposit on the second and fourth passive moisture barrier layer, respectively. In some embodiments, at least one of the first and fifth passive moisture barrier layers comprises PVDC and its copolymers. In some embodiments, at least one of the first and second passive moisture barrier layers comprises PVC and/or amorphous polyethylene terepthalate (APET). In some embodiments, the multilayer structure includes first and second active moisture barrier layers and, respectively, and first, second, third, fourth and fifth passive moisture barrier layers, respectively, comprises an overall thickness of less than or equal to about 508 microns.

In some embodiments, the present invention comprises after the third passive moisture barrier layer, a fourth passive moisture barrier layer. The first, second, third and fourth passive moisture barrier layers and the first active moisture barrier layer are contiguous, non-contiguous or combinations thereof. In some embodiments, the first active moisture barrier layer and the second and third passive moisture barrier layers are co-extruded. In some embodiments, the present multilayer structure further comprises first primer layer disposed between first passive moisture barrier layer and second passive moisture barrier layer, and/or second primer layer disposed between third passive moisture barrier layer and fourth passive moisture barrier layer. In some embodiments, the first and second primer layers, the first active moisture barrier layer and the second and third passive moisture barrier layers are co-extruded. In some embodiments, at least one of the first and fourth passive moisture barrier layers is an aqueous solution prior to deposit on the first and second primer layers, respectively. In some embodiments, at least one of the first and fourth passive moisture barrier layers comprises PVDC. In some embodiments, the present multilayer structure includes first active moisture barrier layer and first, second, third and fourth passive moisture barrier layers, and has an overall thickness of less than or equal to about 508 microns.

### Forming Process

The novel multilayer structures described herein may be formed into a variety of useful articles, e.g., blister packs for pharmaceuticals, trays for food packaging, etc. In various embodiments, the disclosed structures may be thermoformed, molded or formed using any other process known in the art.

In some embodiments, the presently disclosed multilayer structure is used to form a thermoformed article, e.g., blister pack 80. Second and third passive moisture barrier layers 62 and 68, in the example in FIGS. 5 and 6, each comprise a modulus of elasticity less than or equal to a modulus of elasticity of first active moisture barrier layer 64. Although the present multilayer structures may be formed when falling outside of the following glass transition temperature range, it has been found that the thermoformability of the multilayer structure is improved when the glass transition temperature of the polymers used or of the passive moisture barrier layers surrounding the active moisture barrier layer is lower than, equal to or no more than 10° C. greater than the glass transition temperature of the active moisture barrier layer. It was further found that the glass transition temperatures of the various layers should be accounted for in order to ensure a structure will be thermoformable without cracking.

In some embodiments, the thermoformed article is a container for extending the shelf life of moisture degradable pharmaceutical products, e.g., pills 82. In such embodiments, container 80 comprises the thermoformed article forming a plurality of pill receiving chambers 84. Pill 82 is deposited in chamber 84 prior to sealing pack 80 with a sealing layer such as a foil (not shown).

### Passive Moisture Barrier Layers

Passive moisture barrier layers (e.g. 60, 62, and 68 in the examples in FIGS. 5 and 6) provide resistance to the transmission of moisture through such layers due to the characteristics of the materials used to form each respective layer. In some embodiments, at least one of the first, second, third, fourth and fifth passive moisture barrier layers is selected from the group of: polyethylene (PE); PVDC and its copolymers; ethylene vinyl alcohol (EVOH); PCTFE; PVC; polypropylene (PP); polyethylene terephthalate glycol-modified (PETG); amorphous polyethylene terepthalate (APET); polycarbonate; polyolefin; polyolefin copolymers; COC; high impact polystyrene (HIPS); acrylonitrile butadiene styrene (ABS); bi-axially oriented polyethylene terephthalate (BOPET); polystyrene; oriented polypropylene (OPP); polyesters; acrylonitrile-methyl acrylate copolymers; ethylene vinyl acetate (EVA); and, combinations thereof. In various embodiments and applications, the foregoing materials have been found to provide acceptable values of water vapor transmission rates, i.e., the materials act as suitable passive moisture barriers.

In some embodiments, the outermost passive moisture barrier layer or layers, e.g., passive moisture barrier layer 60, depending on which embodiments are considered, may each be in the form of an aqueous solution prior to deposit on the respective adjacent passive moisture barrier layer. In some embodiments, the outermost passive moisture barrier layer or layers, 60, comprises PVDC or copolymers. An advantage of coating PVDC and its copolymers it provides oxygen barrier characteristics too.

### Active Moisture Barrier Layers

Active moisture barrier layers (e.g. 64 in FIGS. 5 and 6) provide resistance to the transmission of moisture through such layers due to a chemical reaction with or adsorption or absorption of water molecules as they diffuse within the layer. Additionally, as described above with respect to the passive moisture barrier layers, some resistance to transmission of moisture is also obtained from the material used to form the active moisture barrier layer. It has been found that active moisture barrier layers in the disclosed multilayer structures comprising a COC and its blends are beneficial, e.g., provide passive moisture barrier characteristics while also providing a medium for carrying an active moisture absorbing composition, and permitting subsequent thermoformability of the multilayer structure after the initial formation thereof.

In contrast to the semi-crystalline polyolefins, e.g., PE and PP, COCs consist of amorphous, transparent copolymers based on cyclic olefins and linear olefins. COCs are a class of polymeric materials having property profiles that can be varied over a wide range during polymerization. Various grades of COC have glass transition temperatures that vary based on norbornene content. Four commercial sources of cyclic olefin resin are available under the TOPAS®, APEL™, ZEONOR®, ZEONEX®, and ARTON® brand names, supplied by Topas Advanced Polymers, Mitsui Chemicals, Zeon Chemical and Japan Synthetic Rubber, respectively. TOPAS® COC is a random copolymer of ethylene and norbornene. Norbornene is synthesized via the Diels-Alder reaction of ethylene and cyclopentadiene. Polymerization of ethylene and norbornene using metallocene catalysts produces COC. Bulky cyclic rings randomly distributed in an ethylenic backbone prevent crystallization of the ethylene units, creating an amorphous morphology. COC grades are distinguished by glass transition temperature and molecular weight. Glass transition temperature (T_{g}) depends on the mole percent of norbornene. The typical commercial T_{g} range is between 33° C. and 170° C. COC has many key property attributes, including but not limited to, exceptional moisture and aroma barrier, chemical resistance, transparency, purity, stiffness and strength.

A disadvantage of COC is that it has a high modulus, a high stiffness, and a low elongation to break, typically less than 15%. Addition of filler materials to polymers further increases their modulus and stiffness and makes them more brittle. Active moisture absorbing compositions are also fillers, typically inorganic ingredients. So, addition of active moisture absorbing ingredients has the same effect of increasing modulus and making the polymer more brittle. To minimize the increase in modulus of filled COC, blends of COC may be used. The blends may be miscible or have low miscibility. Some suitable polymers that may be added to COC include but are not limited to: polyolefins, e.g., high density polyethylene (HDPE), low density polyethylene (LDPE), linear-low density polyethylene (LLDPE); polyolefin copolymers like ethylene propylene copolymer, elastomers, e.g., styrene-ethylene/butylene-styrene (SEBS); and, flexible amorphous or semicrystalline copolymers of COC. An example of an elastomeric form of COC is TOPAS® E-140, a grade offered by Ticona. The elastomeric form has an elongation to break of greater than 300%. In view of the foregoing, it should be appreciated that blends of COC with other polymers to compensate for the increase in stiffness of COC on addition of a filler, e.g., a moisture absorbing composition, may be beneficial and/or necessary.

In some embodiments, at least one of the first and second active moisture barrier layers is selected from the group of: polypropylene (PP); amorphous polyester (APET); ethylene vinyl acetate (EVA); and, combinations thereof. However, it should be appreciated that other materials may also be used in the active layer, and the present invention is not limited to these materials.

The active moisture barrier layers may further comprise a moisture absorbing composition. In some embodiments, the moisture absorbing composition is present in the range of greater than about 10 wt % to less than or equal to about 35 wt %. In some embodiments, the moisture absorbing composition is selected from the group of: calcium oxide; silica gel; molecular sieve; and, combinations thereof. In some embodiments, if there is more than one active moisture barrier layer, then each active moisture barrier layer may contain a unique moisture absorbing composition.

### Primer Layers

Primer layers (e.g. 70 in FIGS. 5 and 6) may be included to perform the function of an adhesive or to enable or enhance adhesion between adjacent layers. The term “primer layer” may be used interchangeably with the term “adhesive layer” or “sealant layer”. Suitable primer layer materials, include but are not limited to: EVA copolymers; maleic anhydride modified polyolefins; copolymers of ethylene, e.g., ethylene methyl acrylate (EMA), ethylene butyl acrylate (EBA), and ethylene ethyl acrylate (EEA); copolymer of ethylene and glycidyl methacrylate; terpolymers of ethylene, methyl acrylate and glycidyl methacrylate; terpolymer of ethylene, butyl acrylate and glycidyl methacrylate; blends of polyolefins; and, combinations thereof.

### Methods of Forming

The presently disclosed multilayer structures may be formed in a number of ways, as in the following non-limiting example embodiments.

One method of forming the novel multilayer structure comprises: (a) forming a base structure, e.g., base structure comprising, in order, a first passive moisture barrier layer, e.g., passive moisture barrier layer 62, a first active moisture barrier layer, e.g., active moisture barrier layer 64, and a second passive moisture barrier layer, e.g., passive moisture barrier layer 68, the first active moisture barrier layer having a first side, and a second side opposite the first side, and comprising a first moisture absorbing composition, e.g., moisture absorbing composition 66, and a COC, the first passive moisture barrier layer disposed on the first side, and the second passive moisture barrier layer disposed on the second side; and, (b) coating a third passive moisture barrier layer, e.g., passive moisture barrier layer 60, on the base structure. In some embodiments, the third passive moisture barrier layer, e.g., passive moisture barrier layer 60, is disposed on a side of the first passive moisture barrier, e.g., passive moisture barrier layer 62, opposite the first active moisture barrier, e.g., active moisture barrier layer 64.

In some embodiments, the third passive moisture barrier layer, e.g., passive moisture barrier layer 60, is in the form of an aqueous solution prior to the step of coating on the base structure. In some embodiments, the third passive moisture barrier layer comprises PVDC and its copolymers.

In some embodiments, the method of forming a present moisture absorbing multilayer structure further comprises: forming a first primer layer, e.g., primer layer 70, on the base structure prior to coating the base structure with the third passive moisture barrier layer, e.g., passive moisture barrier layer 60. The first primer layer is disposed between the third passive moisture barrier layer and the base structure. In some embodiments, the step of forming the base structure comprises co-extruding the first active moisture barrier layer, the first and second passive moisture barrier layers and the first primer layer.

In some embodiments, the method of forming a present moisture absorbing multilayer structure further comprises forming the base structure with the third passive moisture barrier layer coated thereon into a molded form. In some embodiments, the molded form is a blister film, and in some embodiments, the step of forming is performed using a thermoforming apparatus.

In some embodiments, the step of forming the base structure comprises co-extruding the first active moisture barrier layer and the first and second passive moisture barrier layers. In some embodiments, the step of forming the base structure comprises independently extruding each of the first active moisture barrier layer and the first and second passive moisture barrier layers and subsequently laminating, e.g., adhering, the first passive moisture barrier layer, the first active moisture barrier layer and the second passive moisture barrier layer to form the base structure by means known in the art.

It should be appreciated that the method of forming the present moisture absorbing multilayer structure may be performed using a variety of techniques and arrangements of steps. In some embodiments, two or more layers may be co-extruded. For example, a base structure including two passive moisture barrier layers on opposite sides of an active moisture barrier layer may be co-extruded, or a structure including in order, a primer layer, a passive moisture barrier layer, an active moisture barrier layer and a passive moisture barrier layer may be co-extruded. Additionally, in some embodiments, each layer or sub-combination of layers may be extruded separately and subsequently laminated or adhered to each other. For example, each passive moisture barrier layer, active moisture barrier layer and primer layer may be separately extruded followed by a subsequent laminating or adhering process wherein the overall multilayer structure is formed in accordance with the various embodiments described above. Moreover, some layers may be coated on other layers or intermediate structures. For example, the primer layers and/or outermost passive moisture barrier layers may be initially formed in a solution and subsequently coated on an intermediate multilayer structure. It should be further appreciated that the foregoing and following examples are not intended to be limiting and other variations and combinations are also possible. The present invention includes, in certain aspects, a method for reducing the number of manufacturing steps to produce structures that provide equivalent moisture barrier over the desired shelf life in comparison to existing commercially available structures.

Along with moisture barrier, if there is a need to provide oxygen barrier, one of the passive layers could be an EVOH layer which is coextruded with the active layer. EVOH is a co-polymer of ethylene and vinyl alcohol and it provided gas (like oxygen), aroma and grease barrier properties which are a function of the ethylene content. Some coextruded structures containing EVOH layer could be listed as passive layer/active layer containing/tie layer/EVOH layer/tie layer/passive layer or passive layer/active layer/tie layer/EVOH layer/sealant layer; where all the extruded layers belong to the polyolefin and polyolefin copolymer family (no halogenated polymers being used). The tie layer is a thin adhesion promoter layer extruded simultaneously with other layers; and sealant layer is layer which could adhere to lidding foil. These structures lend to easier recycling. Furthermore, the listed multi-layer structure can be manufactured in one step.

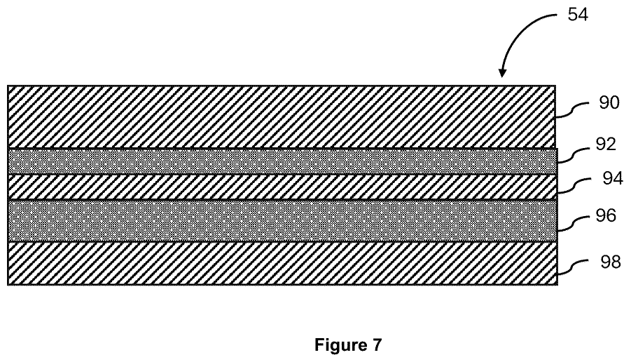

It is not necessary that the thickness of passive or active layers in the structure passive layer/active layer/tie layer/EVOH layer/tie layer/passive layer be equal. In such embodiments, the cross-section is asymmetric or not symmetric. In asymmetric structures, care should be taken to minimize extruded film or sheet curl. This would also be the case for the multilayer structure passive layer/active layer/tie layer/EVOH layer/tie layer/passive layer or sealant layer. Similarly, for the case of moisture absorbing multilayer structure with no oxygen barrier layer (passive or active), the cross-section of the multilayer structure can be symmetric or asymmetric. FIG. 7 is an example of an asymmetric structure multilayer structure 54, comprising: passive layer/active layer/passive layer/active layer/passive layer or sealant layer. In this example, the active moisture absorbing layers 92, 96 are not equal in thickness, while the passive layers are 90, 94, 98, with layers 90 and 98 also not equal in thickness.

In some cases, if EVOH is not used due to limitation of coextrusion equipment or due to other customer reasons, the first passive layer could be a PVDC layer. A typical structure would be PVDC passive layer/primer or adhesion layer/passive layer/active layer/passive layer/sealant layer. In this embodiment, the passive layers may be of unequal thicknesses. The PVDC layer could be applied using certain extrusion grades (Ixan) offered by Synesqo or more typically deposited on the coextruded structure using an aqueous coating after a thin coating of a primer or adhesion layer is applied.

Additional embodiments of a method of forming novel moisture absorbing multilayer structures are described below. The methods described herein, including quantities of materials, temperatures, pressures, times, etc. are not intended to be limiting and are included merely as examples of suitable conditions/compositions for use in forming some embodiments of the novel multilayer structure described herein.

Resin compositions with various additives are mixed in a co-rotating intermeshing twin screw extruder, e.g., the ZSK-25 from Coperion Corporation or ZSK-27 from American Leistritz. Resin compositions are extruded using a coextrusion setup that enables multilayer extrusion. For some variations, a multi-manifold die may be used to form the multilayer structure, while in some instances, a feedblock die is used to form the multilayer structure. In some instances, each layer is extruded separately using a single layer extrusion and the layers subsequently laminated together. Coextrusion of multiple layers enables efficient productivity and was found to enhance the latitude of polymers that can be used for creating the multilayer structure.

For the examples described below, the active moisture barrier layer was made from a COC TOPAS® 8007. The active moisture barrier layer also contained COC elastomer TOPAS® E-140. Furthermore, in order to demonstrate the benefit of an active moisture barrier layer, i.e., a layer including a moisture absorbing composition, calcium oxide was incorporated in the active layer. A variety of grades are available commercially, e.g., Mississippi Lime's POLYCAL® OFT15, a typical grade. Dispersing aids may be included. The second and third passive moisture barrier layers are blends of polyolefins which were compounded on a compounder. For the examples set forth below, the polyolefins are Flint Hills Resources Polypropylene PDP4G3Z03960 and blends of polypropylene with copolymers and elastomers. An example of a copolymer is the INFUSE® 9500 offered by Dow Chemical, an olefin block copolymer which contains alternating blocks of hard (highly rigid) and soft (highly elastomeric) segments. The choice of polymers used in the second and third passive moisture barrier layers and additional component is based on the constraint that their modulus is less than or equal to the modulus of the active moisture barrier layer. Ethylene vinyl acetate copolymer was used as an example of a primer layer. These polymers are available as melt processable grades or solution coating grades. An example of melt processable grade is Repsol's EVA-PA420L. An example of solution coatable grade is DUR-O-SET® E351 which is a low VOC, polyvinyl alcohol stabilized vinyl acetate ethylene copolymer emulsion. For some examples, a passive moisture barrier layer of a PVDC latex was used and aqueous coating techniques were applied. An example of PVDC latex is Owensboro Specialty Polymers, Inc. DARAN® SL112. Other similar grades offered by Owensboro or other companies can be used.

In another embodiment, sheets and films were created and characterized for WVTR on a Mocon PERMATRAN-W® 3/33 unit. The sheets and films were characterized under 23° C. and 90% RH, which is an accelerated condition of humidity with respect to 23° C. having 50% RH as its typical ambient condition. The novel multilayer structure in one embodiment was tested for performance characteristics under accelerated conditions for a flat film embodiment and a blister pack embodiment. The data obtained was then characterized for lag time and total ingress or flux of moisture through shelf life was calculated and compared with some commercially available polymer film structures which contain halogen polymers (like PVC, PCTFE, and PVDC).

Composite density of the novel structures herein was calculated and compared with density of commercially available structures. This was then used to compare the weight per unit area of commercially available film with the novel structures herein for a given footage. This would be a predictor of difference in weight of rolls produced either using the disclosure herein or commercially available products/structures.

### Example 1

A three-layer base structure was made by coextrusion process in one step. The structure included: a passive moisture barrier layer/an active moisture barrier layer/a passive moisture barrier layer. The active moisture barrier layer included 59.2 wt % TOPAS® 8007S-04, 14.8 wt % TOPAS® E140, 25 wt % POLYCAL® OFT15 calcium oxide, and 1 wt % EPOLENE® E14P (a dispersing aid offered by Westlake Chemicals). The passive moisture barrier layer included 80 wt % Flint Hills Polypropylene PDP4G3Z03960 (FHR) and 20 wt % Dow INFUSER 9500. The three layers were co-extruded using a multi-manifold setup, where the resins were processed using lab scale extruders manufactured by Killion and Davis Standard. Sheets of various total thicknesses were made. The total sheet thicknesses ranged from 13 mil (330.2 microns) to 16 mil (406.4 microns). This was accomplished by keeping the extruders at the same output while varying the takeup speed. This example included a flat sheet having a total thickness of 14.17 mil (359.918 microns), with the passive moisture barrier layers being 1.68 mil (42.672 microns) and 1.35 mil (34.29 microns), surrounding a 11.14 mil (282.956 microns) thick active layer. The resulting structure had a ratio of the sum of the thicknesses of the passive moisture barrier layers to the active moisture barrier layer thickness of 0.27:1.

MVTR data collected using the Mocon unit total flux (amount of moisture that passed through the three layer structure and reached the Mocon sensor per area of film) was calculated for various times. From this curve, lag time or time lag as described in FIG. 3 was determined. In this testing, the time lag was found to be 93.75 days at 23° C. and 90% RH, which extrapolates to a time lag of 168.75 days at 23° C. and 50% RH. In view of the test results, a substance can be protected from moisture for about 168 days at ambient conditions, even without using foil, when using the multilayer structure of Example 1. In this example, all three layers were coextruded in one step thereby simplifying manufacturing operations. This result differs from any purely passive barrier non-foil structures which are commercially available, where there is minimal lag time and there is ingress through the structure at every time instant. Furthermore, the resins used in this example are non-halogenated polymers belonging to the family of polyolefins and copolymers like COC.

### Example 2

A three-layer base structure was made, including a passive moisture barrier layer/an active moisture barrier layer/a passive moisture barrier layer. The active moisture barrier layer included 59.2 wt % TOPAS® 8007S-04, 14.8 wt % TOPAS® E140, 25 wt % POLYCAL® OFT15 calcium oxide, and 1 wt % EPOLENE® E14P (a dispersing aid offered by Westlake Chemicals). The passive moisture barrier layer included 70 wt % Flint Hills Polypropylene PDP4G3Z03960 (FHR) and 30 wt % Dow INFUSE® 9500. The layers were co-extruded using a multi-manifold setup, where the resins were processed using lab scale extruders manufactured by Killion and Davis Standard. Sheets of various total thicknesses were made. The total sheet thicknesses ranged from 13 mil to 16 mil. This was accomplished by keeping the extruders at the same output while varying the takeup speed. Flat sheets were tested for WVTR. In this example, a ratio of the sum of the thicknesses of the passive moisture barrier layers to the thickness of the active moisture barrier layer was 0.32:1. When WVTR curves were compared, it is seen that both have similar characteristics, within the composition range of passive moisture barrier layers investigated.

### Example 3

The sheet made similar to Example 2 was drawn to form blisters using a vacuum thermoformer, Formech 508. The blisters were characterized for thickness and thickness uniformity using Magna-Mike 8500. WVTR was characterized on the blisters. Four blisters were tested at the same time. The average thickness of each blister was 3.77 mil (97.758 microns). The total blister film area being exposed to moisture was 11.7 cm². In this example, due to decrease in the overall thickness of the structure, the time range corresponding to near zero MVTR is smaller than that for a flat sheet. It was also seen that that after the active ingredient is fully consumed, the blister starts to achieve a near constant WVTR which is a function of the passive barrier characteristics of the resins used.

### Example 4

This example investigated the WVTR of blisters made from a three-layer coextruded base structure including: a second passive moisture barrier layer/an active moisture barrier layer/a third passive moisture barrier layer. The layers were extruded on a lab coextrusion setup that had two 1″, L:D::24:1 single screw extruders and a ¾″, L:D::24:1 single screw extruder. The resins were extruded through a three layer ULTRAFLOW® I feedblock into an 8″ EDI ULTRAFLEX™ die via adapters. The sheet was cast on a cast roll, and subsequently cooled and wound to form a roll. The roll was then cut to form sheets. The active moisture barrier layer included 59.2 wt % TOPAS® 8007S-04, 14.8 wt % TOPAS® E140, 25 wt % POLYCAL® OFT15 calcium oxide, and 1 wt % EPOLENE® E14P (a dispersing aid offered by Westlake Chemicals). The second and third passive moisture barrier layers included 80 wt % Flint Hills Polypropylene PDP4G3Z03960 (FHR) and 20 wt % Dow INFUSE® 9500. The target total thickness of the structure was 13 mil (330.2 microns), with the passive moisture barrier layers being 1 mil (25.4 microns) each surrounding an 11 mil (279.4 microns) thick active moisture barrier layer. This structure resulted in the ratio of the sum of the thicknesses of the passive moisture barrier layers adjacent to active layer to the thickness of the active moisture barrier layer of 0.18:1. The sheet was successfully thermoformed to a blister by using a vacuum thermoformer, Formech 508. The thickness of the blister was 3.77 mil (95.758 microns). The total blister film area exposed to moisture was 11.7 cm². WVTR of blisters was characterized and it was found that at about 100 hours mark, moisture breakthrough occurred and the WVTR started to increase and at about 1250 hours reached passive barrier characteristics of the polymer composite structure used.

### Example 5

This example investigated the effect of coating a passive moisture barrier layer on the base structure made in Example 4. The final resulting structure included: a first passive moisture barrier layer/a primer layer/a second passive moisture barrier layer/an active moisture barrier layer/a third passive moisture barrier layer. The first passive moisture barrier layer was made up of DARAN® SL112 and applied as an aqueous coating. The target dry coverage for the first passive moisture barrier layer was 85.2 grams/m². The first passive moisture barrier layer was applied on an aqueous coated primer layer that was previously applied onto the second passive moisture barrier layer. The primer layer was made up of DUR-O-SET® E351 and its target dry coverage was 10.4 grams/m². As determined by taking a cross-section of the resultant structure, the thicknesses of each layer in order from the first passive moisture barrier layer are 1.85 mil (46.99 microns), 0.31 mil (7.874 microns), 1.02 mil (25.908 microns), 11.34 mil (288.036 microns), and 1.02 mil (25.908 microns), respectively. The total thickness of the structure is 15.55 mil. This structure results in a ratio of the sum of the thicknesses of the passive moisture barrier layers adjacent to active layer to the active moisture barrier layer thickness of 0.18:1, while the ratio of the active moisture barrier layer thickness to the total structure thickness is 0.73:1. The sheet was thermoformed to a blister such that the PVDC layer, i.e., the first passive moisture barrier layer, was the side opposite from the side forming cavities. The PVDC side was exposed to moisture in the WVTR test units and WVTR as a function of time was characterized. The average thickness of the blisters was 3.99 mil (101.346 microns), while the total blister film area being exposed to moisture was 11.7 cm². The effectiveness of the active moisture barrier layer in this example is enhanced and the WVTR of the blister is nearly zero in the time frame of the test which was 3000 hours (125 days).

### Example 6

This example investigated the thermoformability of the structure including: a first passive moisture barrier layer/a second passive moisture barrier layer/an active moisture barrier layer/a third passive moisture barrier layer. The composition of each layer was the same as set forth in Example 5. The dry thickness coverage of the first passive moisture barrier layer was 85.5 grams/m² and the primer layer was 12.96 grams/m², i.e., both similar to Example 5. The second and third passive moisture barrier layers were 1.79 mil (45.466 microns) and 1.85 mil (46.99 microns), respectively, i.e., thicker than in Example 3. The active moisture barrier layer was 8.87 mil (222.758 microns) thick, i.e., thinner than in Example 5. This structure resulted in a ratio of the sum of the thicknesses of the passive moisture barrier layers adjacent to the active moisture barrier layer to the thickness of the active moisture barrier layer thickness of 0.41:1. The thermoformed blister structures in this example, having an average thickness of 3.76 mil (95.504 microns), demonstrate improved WVTR characteristics.

### Example 7

This example investigated the manufacture of the following coextruded structure: a second passive moisture barrier layer/a first active moisture barrier layer/a third passive moisture barrier layer/a second active moisture barrier layer/a fourth passive moisture barrier layer, and investigated its ability to be thermoformed to form blisters. The thickness of the layers were 1.48 mil (37.592 microns), 6.14 mil (155.956 microns), 1.63 mil (41.402 microns), 6.24 mil (158.496 microns), and 0.77 mil (19.558 microns), respectively. The ratio of the sum of the thicknesses of the passive moisture barrier layers to the sum of the thicknesses of the active moisture barrier layers was 0.31:1. The composition of this structure was thermoformed successfully to form blisters without cracking.

### Example 8

This example investigated the creation of a coextruded structure: a first primer layer/a second passive moisture barrier layer/a first active moisture barrier layer/a third passive moisture barrier layer/a second primer layer. The second and third passive layer compositions and the active layer composition were the same as described in Example 5. The first and second primer layers were made of melt processable EVA, ALCUDIA® PA-420L. The adhesion of the EVA layer to the passive layer, as well as the adhesion of the passive layers to the active layer were all very good. The thickness of each layer from the first primer layer 1 onwards was found to be 0.59 mil (14.986 microns), 1.19 mil (30.226 microns), 9.68 mil (245.872 microns), 1.12 mil (28.448 microns), and 0.56 mil (14.224 microns), respectively. The ratio of sum of the thicknesses of the passive moisture barrier layers adjacent to the active moisture barrier layer to the active moisture barrier layer thickness was found to be 0.24:1. The sample was thermoformed to form blisters without any cracks. The second primer layer can also serve as a sealant layer.

### Example 9

A roll formed in Example 8 was aqueous coated with a passive moisture barrier layer. The coated passive moisture barrier layer was DARAN® SL112 at a target dry coverage of 85.5 grams/m². The structure formed after coating resulted in: a first passive moisture barrier layer/a first primer layer/a second passive moisture barrier layer/a first active moisture barrier layer/a third passive moisture barrier layer/a second primer layer. The adhesion of the first passive moisture barrier layer to the first primer layer was found to be very good. Furthermore, thermoformability of this structure did not introduce any cracks. The structure formed had an estimated ratio of the thickness of the active layer to the total thickness of 0.65:1. An advantage of the structure in this example is the second primer layer can also serve as a sealant layer.

### Example 10

A roll formed in Example 9 was aqueous coated with a passive moisture barrier layer on the side opposite to the first passive moisture barrier layer. This forms a fourth passive moisture barrier layer and also forms a sealant layer in certain applications, i.e., the selection of the type of passive moisture barrier layer defines its application. The coated passive moisture barrier layer was DARAN® SL112 at a target dry coverage of 28.5 grams/m². The structure formed after coating included: a first passive moisture barrier layer/a first primer layer/a second passive moisture barrier layer/a first active moisture barrier layer/a third passive moisture barrier layer/a second primer layer/a fourth passive moisture barrier layer. The adhesion of the fourth passive moisture barrier layer to the second primer layer was found to be very good. In this example, the compositions of the first passive moisture barrier layer and the fourth passive moisture layer are same. Wax coated paper was introduced as an interleaf during rolling of the structure to prevent blocking between surfaces. This structure exhibited acceptable thermoformability as no cracks occurred during forming. The formed structure, i.e., a blister pack, was sealed to foil lidstock.

### Example 11

This example investigates creation of a coextruded structure: a first passive moisture barrier layer/a first active moisture barrier layer/a second passive moisture barrier layer/a first primer layer. The first and second passive moisture barrier layer compositions and the first active moisture barrier layer composition is same as described in Example 5. The first primer layer was made of melt processable EVA, ALCUDIA® PA-420L. The adhesion of the EVA layer to the third passive moisture barrier layer, as well as the adhesion of passive moisture barrier layers to the active moisture barrier layer were all very good. The thickness of each layer from the second passive moisture barrier layer onwards was found to be 0.89 mil (22.606 microns), 11.12 mil (282.448 microns), 1.39 mil (35.306 microns), and 0.30 mil (7.62 microns), respectively. The total thickness of the structure was 13.71 mil (348.234 microns). This structure was thermoformed successfully without any cracks with the primer layer being the layer that adheres to the foil lidstock. Hence, the primer layer serves as a sealant layer. Additionally, this example describes another complete structure that can be used in a sheet form where the primer layer performs the function of a sealant layer or a blister where the primer layer acts as a sealant layer to the lidstock. The ratio of the sum of the thicknesses of the passive moisture barrier layers adjacent to the active moisture barrier layer to the active moisture barrier layer thickness was found to be 0.21:1 and the ratio of the thickness of the active moisture barrier layer to the total thickness was found to be 0.81:1.

From the above examples, it has been shown, among other things, that appropriate modification of the active moisture barrier layer to account for stiffness and high modulus of the filled COC using an elastomer, and also surrounding the active moisture barrier layer with passive moisture barrier layers with modulus equivalent to or lower than the active moisture barrier layer enables effective post processing, e.g., thermoforming to form blisters. Furthermore, it is observed from the examples that composite polymer film or sheet structures with very good moisture barrier can be created using non-halogenated polymers and some of these structures can be created in one step extrusion operation using co-extrusion.

Table 1 lists the densities of polymers used in the above experiments obtained from suppliers and open literature.

TABLE 1

| | Supplier (if used in | |
|---|---|---|
| Resin or Material | experiments) | Density (g/cc) |
| Polypropylene | Flint Hills | 0.9 |
| PDP4G3Z03960 | | |
| Olefinic block copolymer | Dow chemical | 0.877 |
| Infuse 9500 | | |
| Cyclic olefin copolymer | Topas | 1.02 |
| Topas 8007S-04 | | |
| Cyclic olefin copolymer | Topas | 0.94 |
| elastomer Topas E-140 | | |
| Calcium oxide Polycal | Mississippi Lime | 3.2 |
| OFT15 | | |
| PCTFE | | 2.1-2.17 (open |
| | | literature) |
| PVC | | 1.38 (open literature) |
| PVDC Daran SL112 | Owensboro Specialty | 1.63-1.72 (open |
| | Polymers | literature) |

Additional findings are provided in Tables 2 to Table 4 below. Tables 2 and 3 compare the composite density and weight of equivalent area of commercially available barrier laminates with structures disclosed herein. The weight of equivalent area is a way of representing basis weight or weight of sample for a given width and length. It gives a perspective on how different roll weights for equivalent length would be. The composite density is calculated using the following equation

$${ρ}_{comp} = {M}_{total} / ( {M}_{a} / {ρ}_{a} + Mb / ρ b + Mc / ρ c + … )$$

where ρ_{comp} is the composite density, Mₜₒₜₐₗ is the total mass of a unit area of multilayer polymer structure, Mₐ, M_{b}, M_{c} are masses of individual polymer layers, with ρₐ, ρ_{b}, ρ_{c} being their corresponding densities of each individual polymer layer. The above equation can be used to calculate density of polymer layer (e.g. active layer) by accounting for masses and densities of various components used to construct it.

In Table 2, it is seen that the novel multilayer structures do not contain halogenated polymers and the composite density of the novel multilayer structures disclosed herein are lower than the comparative examples shown. The inventive examples also weigh less, and as a result the roll weight for equivalent footage is lower. The inventive examples also use less polymer to create the multilayer structure since the active layer contains 25 wt % of an inorganic material calcium oxide which is manufactured from calcining naturally occurring raw materials like limestone, chalk or seashells. Another observation from Table 2 is the inventive example can be created in one coextrusion step, when the active layer resin is created by direct sheet extrusion where compounding of active agent and extrusion is done by a twin screw extruder. In contrast, the comparative example requires manufacturing steps to create PVC film and PCTFE film separately and then laminate the structure in a separate step after application of a primer or adhesion layer. Hence, three to four manufacturing steps are required to create the comparative example listed in Table 2. The inventive examples in Table 2 have near equivalent moisture ingress over a time span of two years at ambient conditions of 23° C., 50% RH. For cases of less than time span less than two years, for example one year moisture ingress will be less than comparative example since there is a time lag before moisture ingresses through when an active layer is used as part of a multilayer structure.

TABLE 2

| | | | Sheet | | |
|---|---|---|---|---|---|
| | | | Thick- | Calculated | Weight of |
| | | | ness | composite | 3000 cm² |
| | | | (mi- | density | area sheet |
| Example | Structure | Source | crons) | (g/cc) | (g) |
| Compar- | 127 micron | e.g. Tekni | 269 | 1.422 | 1147.635 |
| ative | PVC/15 micron | Plex | | | |
| Example | PCTFE/127 | | | | |
| 1 | micron PVC | | | | |
| Inventive | 25.4 micron PP | Disclosed | 304.8 | 1.158 | 1059.04 |
| Example | passive layer/ | structure | | | |
| 11 | 254 COC | (coex- | | | |
| | active layer | trusion) | | | |
| | containing | | | | |
| | 25 wt % CaO/ | | | | |
| | 25.4 micron PP | | | | |
| | passive layer | | | | |
| Inventive | 50.8 micron PP | Disclosed | 304.8 | 1.208 | 1105.05 |
| Example | passive layer/ | structure | | | |
| 12 | 203.2 COC | (coex- | | | |
| | active layer | trusion) | | | |
| | containing | | | | |
| | 35 wt % CaO/ | | | | |
| | 50.8 micron PP | | | | |
| | passive layer | | | | |

Table 3 provides examples of structures where different grammage weight of PVDC has been coated on various substrates. Grammage is indicated by gsm and it stands for g/m² a measure of coverage used in the industry for coatings. Table 3 highlights that the novel structure disclosed herein is able to provide structures that are lower in density than commercially available pure halogenated polymer structures. It is also seen that for equivalent unit area, weight of the inventive samples is lower than the comparative examples. This results in lower roll weights being transported to a customer that converts these films and sheets to thermoformed containers like blisters.

TABLE 3

| | | | Sheet | | |
|---|---|---|---|---|---|
| | | | Thick- | Calculated | Weight of |
| | | | ness | composite | 3000 cm2 |
| | | | (mi- | density | area sheet |
| Example | Structure | Source | crons) | (g/cc) | (g) |
| Compar- | 40 gsm PVDC/ | e.g. Tekni | 273.82 | 1.406 | 1154.735 |
| ative | 250 micron | Plex | | | |
| Example | PVC | | | | |
| 2 | | | | | |
| Inventive | 40 gsm PVDC/ | Disclosed | 252.48 | 1.128 | 854.184 |
| Example | 50.8 micron PP | structure | | | |
| 13 | passive layer/ | (aqueous | | | |
| | 127 micron | coating on | | | |
| | COC active | coex- | | | |
| | layer | truded | | | |
| | containing | structure) | | | |
| | 25 wt % CaO/ | | | | |
| | 50.8 micron PP | | | | |
| | passive layer | | | | |
| Compar- | 60 gsm PVDC/ | e.g. Tekni | 285.76 | 1.417 | 1214.735 |
| ative | 250 micron | Plex, | | | |
| Example | PVC | Liveo | | | |
| 3 | | Research | | | |
| Inventive | 60 gsm PVDC/ | Disclosed | 264.42 | 1.152 | 914.184 |
| Example | 50.8 micron PP | structure | | | |
| 14 | passive layer/ | (aqueous | | | |
| | 127 micron | coating on | | | |
| | COC active | coex- | | | |
| | layer | truded | | | |
| | containing | structure) | | | |
| | 25 wt % CaO/ | | | | |
| | 50.8 micron PP | | | | |
| | passive layer | | | | |

As observed from experimental examples (like Example 1), there is a significant amount of time required to carry out testing of active layer structures since time lag (measure of when moisture breaks through) is in measure of days and months. As a result, theoretical models based on Fickian diffusion and reaction kinetics can be developed to accelerate the development timeline. Input for these models are permeabilities of polymers and thickness of the layers. One source to obtain the permeabilities is commercial literature for the resins used as well as the commercial structures technical data sheets. Another source is the report issued by Paul E. Keller and Richard Kouzes, “Water Vapor Permeation in Plastics”, PNNL-26070 in January 2017.

Based on these models, Tables 4 and 5 provide a theoretical estimate of lag times, moisture ingress through the various structures highlighted in Tables 2 and 3. It is observed from Tables 4 and 5, multilayer structures constructed using only non-halogenated polymers with an active layer or a structure made up of halogenated polymers with active COC layers and passive polyolefin layers as disclosed herein result in moisture ingress less than or nearly equivalent to existing commercial structures. Also, lower roll weights for equivalent length are found in the inventive structures listed in the Tables. Hence, overall, less polymer is being used to make the roll thus resulting in lower shipping or transportation costs and a lower carbon footprint. Furthermore, it is understood for customer applications that require shorter shelf-life times, the inventive structures will have very low moisture ingress as indicated by the lag times.

TABLE 4

| | | | | | Calculated |
|---|---|---|---|---|---|
| | | | | | Moisture |
| | | | | | ingress |
| | | | Estimated | Calculated | over 2 |
| | | WVTR | WVTR | Time lag | years @ |
| | | (g/m²-day, | (g/m²-day, | at 23° C., | 23° C., |
| | | 38° C., | 23° C., | 50% RH | 50% RH |
| Example | Structure | 90% RH) | 50% RH) | (days) | (g/m²) |
| Compar- | 127 micron | 0.37 | 0.103 | 0 | 75.03 |
| ative | PVC/15 | | | | |
| Example | micron | | | | |
| 1 | PCTFE/127 | | | | |
| | micron PVC | | | | |
| Inventive | 25.4 micron | — | 0.11407 | 99.66 | 71.92 |
| Example | PP passive | | | | |
| 10 | layer/254 | | | | |
| | COC active | | | | |
| | layer | | | | |
| | containing | | | | |
| | 25 wt % | | | | |
| | CaO/25.4 | | | | |
| | micron PP | | | | |
| | passive layer | | | | |
| Inventive | 50.8 micron | — | 0.12387 | 112.24 | 76.52 |
| Example | PP passive | | | | |
| 11 | layer/203.2 | | | | |
| | COC active | | | | |
| | layer | | | | |
| | containing | | | | |
| | 35 wt % | | | | |
| | CaO/50.8 | | | | |
| | micron PP | | | | |
| | passive layer | | | | |

TABLE 5

| | | | | | Calculated |
|---|---|---|---|---|---|
| | | | | | Moisture |
| | | | | | ingress |
| | | | Estimated | Calculated | over 2 |
| | | WVTR | WVTR | Time lag | years @ |
| | | (g/m²-day, | (g/m²-day, | at 23° C., | 23° C., |
| | | 38° C., | 23° C., | 50% RH | 50% RH |
| Example | Structure | 90% RH) | 50% RH) | (days) | (g/m²) |
| Compar- | 40 gsm | 0.65 | 0.18 | — | 131.81 |
| ative | PVDC/250 | | | | |
| Example | micron PVC | | | | |
| 2 | | | | | |
| Inventive | 40 gsm | — | 0.04994 | 195.26 | 26.7 |
| Example | PVDC/50.8 | | | | |
| 12 | micron PP | | | | |
| | passive | | | | |
| | layer/127 | | | | |
| | micron COC | | | | |
| | active layer | | | | |
| | containing | | | | |
| | 25 wt % | | | | |
| | CaO/50.8 | | | | |
| | micron PP | | | | |
| | passive | | | | |
| | layer | | | | |
| Compar- | 60 gsm | 0.5 | 0.14 | — | 101.39 |
| ative | PVDC/250 | | | | |
| Example | micron PVC | | | | |
| 3 | | | | | |
| Inventive | 60 gsm | — | 0.0368 | 276.69 | 16.67 |
| Example | PVDC/50.8 | | | | |
| 13 | micron PP | | | | |
| | passive | | | | |
| | layer/127 | | | | |
| | micron COC | | | | |
| | active layer | | | | |
| | containing | | | | |
| | 25 wt % | | | | |
| | CaO/50.8 | | | | |
| | micron PP | | | | |
| | passive | | | | |
| | layer | | | | |

The examples highlight the versatility of the present invention. Some of the novel structures, e.g., Examples 6 and 9, could be used to laminate to other films like PVC on the side containing a primer layer. The primer layer composition in these examples could further be modified to enable adhesion to APET. It is believed that the presently disclosed embodiments of the multilayer structure and method, and articles formed therefrom, may also be used in certain applications to eliminate the need for a foil layer and/or materials such as PCTFE.

While an improved structure and method for environmentally friendly blister packaging is described with respect to what are presently considered to be preferred embodiments, and a number of alternatives described, it is to be understood that the disclosure is not intended to be limited to the disclosed embodiments. Changes and modifications may be made, and persons skilled in this art will appreciate that various additional changes and modifications may be made without departing from the spirit of the invention. It is also understood that the terminology used herein is for the purpose of describing particular embodiments, and is not intended to limit the scope of the applicant's inventions.

What is claimed is:

1. A multilayer, sustainable moisture barrier for a blister pack, comprising:
a first passive layer comprising a non-halogenated polymer;
a first active layer comprising cyclic olefin copolymer (COC) and a moisture absorbing composition;
a second passive layer comprising a non-halogenated polymer;
wherein the modulus of elasticity of said first and second passive layers is lower than the modulus of elasticity of said first active layer.

2. The sustainable moisture barrier of claim 1, wherein one or more of said layers are asymmetric.

3. The sustainable moisture barrier of claim 1, wherein said first passive layer and said second passive layer are not equal in thickness

4. The sustainable moisture barrier of claim 1, wherein said first passive layer and said first active layer are not equal in thickness.

5. The sustainable moisture barrier of claim 1, wherein said first passive layer, second passive layer and first active layer are co-extruded.

6. The sustainable moisture barrier of claim 1, wherein said first passive layer, second passive layer and first active layer comprise polyolefins or copolymers of polyolefins.

7. The sustainable moisture barrier of claim 1, further comprising a second active layer comprising cyclic olefin copolymer (COC) and a moisture absorbing composition.

8. The sustainable moisture barrier of claim 7, wherein said first active layer and said second active layer are not equal in thickness.

9. The sustainable moisture barrier of claim 7, wherein the ratio between the combined thickness of said first active layer and said second active layer, and the thickness of the entire multilayer moisture barrier, is between 0.41:1 and 0.82:1.

10. The sustainable moisture barrier of claim 7, wherein at least one of said first active layer and said second active layer is selected from the group of: polypropylene (PP), amorphous polyester (APET), and ethylene vinyl acetate (EVA).

11. The sustainable moisture barrier of claim 7, wherein said moisture absorbing composition in said first active layer is selected from the group consisting of calcium oxide, silica gel, activated alumina and molecular sieve; and said moisture absorbing composition in said second active layer is a different moisture absorbing composition.

12. The sustainable moisture barrier of claim 1, wherein said first passive layer and said second passive layer are contiguous with said first active layer, and the ratio between the combined thickness of said first passive layer and said second passive layer, and the thickness of said first active layer, is between 0.18:1 and 0.61:1.

13. The sustainable moisture barrier of claim 1, further comprising a first primer layer disposed between said first passive layer and said second passive layer, said first primer layer configured to enhance adhesion between adjacent layers.

14. The sustainable moisture barrier of claim 13, wherein said first passive layer is an aqueous solution deposited on said first primer layer.

15. The sustainable moisture barrier of claim 14, wherein said first passive layer is the outermost layer.

16. The sustainable moisture barrier of claim 13, further comprising:
a third passive layer comprising a non-halogenated polymer;
a fourth passive layer comprising a non-halogenated polymer; and
a second primer layer disposed between said third passive layer and said fourth passive layer.

17. The sustainable moisture barrier of claim 13, wherein said first primer layer comprises an EVA copolymer, a maleic anhydride modified polyolefin, ethylene methyl acrylate (EMA), ethylene butyl acrylate (EBA), ethylene ethyl acrylate (EEA), copolymer of ethylene and glycidyl methacrylate, terpolymers of ethylene, methyl acrylate and glycidyl methacrylate, terpolymer of ethylene, or butyl acrylate and glycidyl methacrylate.

18. The sustainable moisture barrier of claim 13, wherein said first primer layer serves as a sealant layer.

19. The sustainable moisture barrier of claim 1, wherein said moisture absorbing composition is selected from the group consisting of calcium oxide, silica gel and molecular sieve.

20. The sustainable moisture barrier of claim 1, wherein said first passive layer comprises ethylene vinyl alcohol (EVOH) for providing an oxygen barrier; and wherein said first passive layer is coextruded with said first active layer.

21. A thermoformed container comprising the sustainable moisture barrier of claim 1.

22. The sustainable moisture barrier of claim 1, wherein the total thickness of the multilayer structure is less than 508 microns, and its composite density is less than 1.25 g/cc.

23. The sustainable moisture barrier of claim 1, wherein said first active layer or said second active layer comprises COC blends.

24. A multilayer sustainable moisture barrier for a blister pack, comprising:
a first non-halogenated passive moisture barrier layer;
a first active moisture absorbing layer contiguous with said first passive moisture barrier layer, comprising cyclic olefin copolymer (COC) and a moisture absorbing composition;
a second non-halogenated passive moisture barrier layer;
a second active moisture absorbing layer contiguous with said second passive moisture barrier layer, comprising cyclic olefin copolymer (COC) and a moisture absorbing composition; and
a third non-halogenated passive moisture barrier layer.

25. The multilayer sustainable moisture barrier of claim 24, wherein said first and second active moisture absorbing layers are not equal in thickness.

26. The multilayer sustainable moisture barrier of claim 24, said first, second and third non-halogenated passive moisture barrier layers are not equal in thickness.

27. The multilayer sustainable moisture barrier of claim 24, wherein both of said second and third passive moisture barrier layers have a modulus of elasticity less than or equal to the modulus of said first and second active moisture absorbing layers.

28. The multilayer sustainable moisture barrier of claim 24, wherein said first passive moisture barrier layer, second passive moisture barrier layer and first active moisture absorbing layer are co-extruded.

29. The sustainable moisture barrier of claim 24, wherein said first active layer or said second active layer comprises COC blends.

30. A thermoformed blister pack comprising the sustainable moisture barrier of claim 24.
